(19) United States
(12) Patent Application Publication
(10) Pub. No.: US 2026/0209083 A1
(43) Pub. Date: Jul. 23, 2026

(54) METHOD FOR PHOTOCATALYTIC DEGRADATION OF PERFLUOROOCTANOIC ACID IN WATER USING GROUP IIIA METAL HYDROXIDES

(71) Applicant: NANJING UNIVERSITY, Jiangsu (CN)

(72) Inventors: Ruijuan Qu, Jiangsu (CN); Mengqiang He, Jiangsu (CN); Xiaoyu Li, Jiangsu (CN); Zhenyang Qin, Jiangsu (CN); Dongmei Zhou, Jiangsu (CN); Zunyao Wang, Jiangsu (CN)

(73) Assignee: NANJING UNIVERSITY, Jiangsu (CN)

(21) Appl. No.: 19/455,770

(22) Filed: Jan. 21, 2026

(30) Foreign Application Priority Data
Jan. 23, 2025 (CN) 202510108304.8

(51) Int. Cl. C02F 1/32; B01J 23/08; B01J 35/39; C02F 101/36

(52) U.S. Cl. CPC C02F 1/325; B01J 23/08; B01J 35/39; C02F 2101/36; C02F 2201/32

(57) ABSTRACT

A method for photocatalytic degradation of perfluorooctanoic acid (PFOA) in water using group IIIA metal hydroxides includes the following steps: adding group IIIA metal hydroxide as a photocatalyst to a water body containing PFOA, and performing a photocatalytic degradation reaction under a light source after sufficient mixing, where the light source is ultraviolet light, yellow light, or red light, and a pH range of the water body containing PFOA is 3-7. The present disclosure performs photocatalytic degradation of PFOA by using a series of group IIIA metal hydroxides (Al(OH)₃, Ga(OH)₃, and In(OH)₃) with low cost and simple preparation process, which not only improves the degradation efficiency of PFOA in water, but also achieves the photocatalytic degradation under different light sources and a relatively wide pH range, expands an application range of photocatalysis, and facilitates treatment of PFOA-contaminated water bodies in practical production.

### CROSS-REFERENCE TO RELATED APPLICATION

This application claims the priority benefit of China application serial no. 202510108304.8, filed on Jan. 23, 2025. The entirety of the above-mentioned patent application is hereby incorporated by reference herein and made a part of this specification.

### BACKGROUND

### Technical Field

The present disclosure relates to the field of sewage degradation, and particularly relates to a method for photocatalytic degradation of perfluorooctanoic acid in water using group IIIA metal hydroxides.

### Description of Related Art

Perfluorooctanoic acid (PFOA) has been defined as a “persistent organic pollutant” due to its strong persistence, bioaccumulation, and toxicity, and has been classified as a Group 1 carcinogen. Transformation and removal of PFOA in the environment have attracted considerable attention. Therefore, it is necessary to explore efficient and low-cost degradation methods to improve the degradation efficiency of PFOA.

Currently, various types of photocatalysts have been used for the degradation of PFOA, mainly including semiconductor photocatalysts such as titanium dioxide, gallium oxide, and indium oxide. Photocatalytic reaction systems with group IIIA metal hydroxides (indium oxide and gallium oxide) as catalysts effectively degrade PFOA under relatively mild conditions. However, photocatalysts in the prior art still have defects such as the complex preparation process, high synthesis cost, and harsh reaction conditions, which limit their practical application in environmental technology. Therefore, it is necessary to explore other efficient and low-cost catalysts.

### SUMMARY

Invention objective: An objective of the present disclosure is to provide a method for photocatalytic degradation of perfluorooctanoic acid (PFOA) in water using group IIIA metal hydroxides with a simple synthesis process and high degradation efficiency.

Technical solution: The method for photocatalytic degradation of PFOA in water using group IIIA metal hydroxides of the present disclosure includes the following steps: adding group IIIA metal hydroxide as a photocatalyst to a water body containing PFOA, and performing a photocatalytic degradation reaction under a light source after sufficient mixing.

Further, the group IIIA metal hydroxide is aluminum hydroxide, gallium hydroxide, or indium hydroxide, preferably aluminum hydroxide.

Further, a mass ratio of PFOA to aluminum hydroxide is 1:8-12, preferably 1:10.6.

Further, a mass ratio of PFOA to gallium hydroxide is 1:300-600, preferably 1:400.

Further, a mass ratio of PFOA to indium hydroxide is 1:40-60, preferably 1:56.

Further, an alkali precipitation method is employed for preparing the group IIIA metal hydroxides, including the following steps: dropwise adding a sodium hydroxide solution of a first concentration to a solution containing aluminum salt, gallium salt or indium salt to generate a white flocculent precipitate, then dropwise adding a sodium hydroxide solution of a second concentration to completely generate a precipitate, washing the precipitate with a solvent, drying to obtain a solid, and cooling and grinding the solid, where obtained solid powder is group IIIA metal hydroxide.

Further, a concentration of the sodium hydroxide solution of a first concentration is set to 8-10 M to generate a certain amount of flocculent precipitate, and a concentration of the sodium hydroxide solution of a second concentration is set to 1-2 M to control an excessive particle size of generated Al(OH)₃, Ga(OH)₃, or In(OH)₃, and prevent pH jump.

Further, the aluminum salt, the gallium salt, or the indium salt is aluminum nitrate nonahydrate (Al(NO₃)₃·9H₂O), or gallium(III) nitrate hydrate (Ga(NO₃)₃·xH₂O), or indium nitrate hydrate (In(NO₃)₃·xH2O).

Further, premixing is required before the photocatalytic degradation reaction, including: mixing the solid powder of group IIIA metal hydroxides with the water body containing PFOA and stirring in the dark for 2.0-4.0 h, such that PFOA is fully adsorbed on a surface of the solid powder of group IIIA metal hydroxides.

Further, a pH range of the water body containing PFOA is 3-7, preferably 7.

Further, the acid used for pH adjustment of the water body containing PFOA is hydrochloric acid, and the alkali is sodium hydroxide.

Further, the light source is ultraviolet light, yellow light, or red light.

Further, conditions of the degradation reaction include: reacting at 24-26° C. for 24-50 h.

Further, a concentration range of PFOA in the water body is 1.0 mg/L to 100.0 mg/L.

Beneficial effects: Compared with the prior art, the present disclosure has the following significant advantages: (1) A series of group IIIA metal hydroxides (Al(OH)₃, Ga(OH)₃, and In(OH)₃) adopted in the present disclosure enable efficient photocatalytic degradation of PFOA, and photocatalysis in a relatively wide pH range simultaneously with photodegradation under different light sources, thereby greatly broadening an application range of PFOA degradation and facilitating the treatment of PFOA-contaminated water bodies in practical production; (2) the present disclosure prepares the group IIIA metal hydroxides according to the alkali precipitation method, with a simple and time-saving synthesis process; (3) experimental verification results show that after 48 h of UV irradiation, the degradation efficiency of PFOA is increased by up to 33.6%, and after irradiation with yellow light or red light (LED lamp), the reaction efficiency of the photocatalytic system of PFOA by Al(OH)₃, Ga(OH)₃, or In(OH)₃ is increased by up to 23.5% compared with that of a single PFOA photolysis system.

### BRIEF DESCRIPTION OF THE DRAWINGS

FIG. 1A~1F illustrate transmission electron microscopy (TEM) images and X-ray diffraction (XRD) patterns of Al(OH)₃, Ga(OH)₃, or In(OH)₃ prepared in Example 1, where FIG. 1A~1C are TEM images and FIG. 1D~1F are XRD patterns.

FIG. 2 illustrates a self-made photoreaction apparatus in Example 4.

FIG. 3 illustrates degradation efficiency of group IIIA metal hydroxides on PFOA under a 300 W mercury lamp in Examples 1 to 3.

FIG. 4 illustrates degradation efficiency of group IIIA metal hydroxides on PFOA under yellow light in Examples 4 to 6 and under red light in Examples 7 to 9.

FIG. 5 illustrates utilization efficiency of group IIIA metal hydroxides.

FIG. 6 is a schematic diagram of PFOA degradation and a photocatalytic mechanism of group IIIA metal hydroxides.

FIG. 7 illustrates Zeta potentials of three group IIIA metal hydroxides under different pH values.

FIG. 8 illustrates Fourier transform infrared (FT-IR) spectra of group IIIA metal hydroxides, PFOA and corresponding adsorption samples.

FIG. 9 illustrates 19F nuclear magnetic resonance (NMR) spectra.

FIG. 10A~10C illustrate ultraviolet-visible diffuse reflectance absorption spectra of three group IIIA metal hydroxides.

FIG. 11A~11C illustrate emission spectra of three group IIIA metal hydroxides under 650 nm variable power excitation, and FIG. 11D~11F are the fitting graphs of luminescence intensities and excitation power.

### DESCRIPTION OF THE EMBODIMENTS

The present disclosure will be further described below with reference to specific embodiments and accompanying drawings.

Example 1: A method for photocatalytic degradation of perfluorooctanoic acid (PFOA) in water using group IIIA metal hydroxides provided in this example includes the following steps:
(1) Photocatalysts-group IIIA metal hydroxides Al(OH)₃, Ga(OH)₃, and In(OH)₃ were prepared:

375.1 g of Al(NO₃)₃·9H₂O (or 255.7 g of Ga(NO₃)₃·xH₂O, or 300.8 g of In(NO₃)₃·xH₂O) was placed in a beaker and completely dissolved in water, first 8 M NaOH was dropwise added to a resulting solution, and 8 M NaOH was replaced with 1 M NaOH after a white flocculent precipitate was initially formed; a pH value of the solution was monitored simultaneously, and NaOH was added until the pH value of the solution reached 7, and Al³⁺, Ga³⁺, or In³⁺ in the solution was completely precipitated as Al(OH)₃, Ga(OH)₃, or In(OH)₃; and in this case, adding of NaOH was stopped for static precipitation, then a supernatant was poured out, a resulting precipitate was washed with methanol and purified water for 2-3 times to remove soluble impurities in the precipitate, the precipitate was dried at 120° C., and a generated solid was collected, cooled, and ground to obtain 78.0 g of Al(OH)₃, or 120.7 g of Ga(OH)₃, or 165.8 g of In(OH)_{3.}

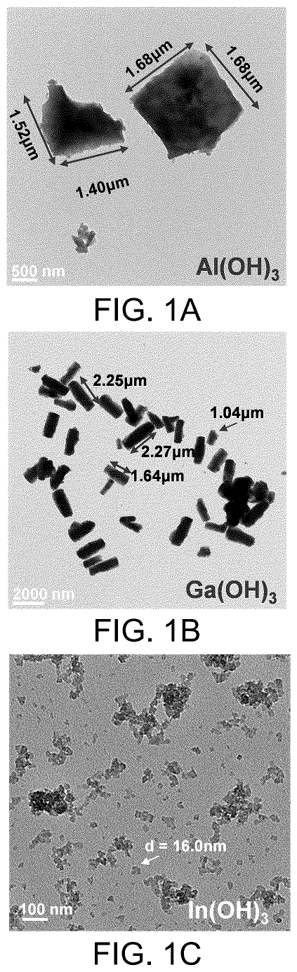

Characterization tests were performed on the prepared group IIIA metal hydroxides, as shown in FIG. 1. FIG. 1A illustrates a transmission electron microscopy (TEM) image of the Al(OH)₃ catalyst, and it can be seen from the figure that the synthesized Al(OH)₃ has a regular or incompletely regular sheet-like structure, where the incompletely regular sheet-like Al(OH)₃ has a length of 1.40 μm and a width of 1.52 μm, and the regular sheet-like structure is approximately square, having a length and width of about 1.68 μm. FIG. 1B illustrates a TEM image of the Ga(OH)₃ catalyst, and it can be seen from the figure that the synthesized Ga(OH)₃ has a regular rod-like structure with a length of about 1.04-2.27 μm. FIG. 1C illustrates a TEM image of the In(OH)₃ catalyst, and it can be seen from the figure that the synthesized In(OH)₃ has a spherical structure with a diameter of about 16 nm.

FIG. 1D illustrates an X-ray diffraction (XRD) pattern of the Al(OH)₃ catalyst, and the Al(OH)₃ synthesized by an alkali precipitation method has sharp characteristic peaks at 18.9°, 20.3°, 27.8°, 40.7° and 53.2°, which belong to (001), (110), (111), (13-1), and (202) crystal planes respectively. FIG. 1E illustrates an XRD pattern of the Ga(OH)₃ catalyst, and the synthesized Ga(OH)₃ has (020), (110), (120), (130), (021), (111) and (140) crystal planes. FIG. 1F illustrates an XRD pattern of the synthesized In(OH)₃ catalyst that has obvious (200) and (400) crystal planes.

The above characterization results indicate that the group IIIA metal hydroxides Al(OH)₃, Ga(OH)₃, and In(OH)₃ were successfully synthesized.
(2) 100 mg of a PFOA solid was weighed and placed in a 1.0 L volumetric flask, and stirred and dissolved to make up to volume to obtain a 100 mg/L PFOA stock solution;
(3) a 300 W mercury lamp was placed in an XPA-7 photochemical reactor and preheated for 30 min to achieve stable light intensity output; and
(4) 7.5 mL of the 100 mg/L PFOA stock solution was uniformly mixed with 142.5 mL of deionized water uniformly to obtain a mixed solution, a pH value of the mixed solution was adjusted to 7, and 8 mg of the group IIIA metal hydroxide Al(OH)₃ was added to the mixed solution, where a concentration of Al(OH)₃ in the mixed solution is 53.3 mg/L, and a concentration of PFOA in the mixed solution is 5 mg/L; and then stirring in the dark was performed for 2 h to reach an adsorption equilibrium, 30.0 mL of the solution was placed in a quartz tube for a light irradiation reaction, a lampshade of the photochemical reactor was pulled down at a preset reaction time point, 1.0 mL of a reaction solution was extracted from a photoreaction tube into a 10 mL plastic centrifuge tube, 4 mL of methanol was added, and a resulting mixture was stirred and extracted for 40 min, where a high performance liquid chromatography-mass spectrometry (HPLC-MS) was used to monitor PFOA concentration changes and calculate PFOA degradation rates.

Example 2: The difference from Example 1 lies in that in the step (3), 300 mg of group IIIA metal hydroxide Ga(OH)₃ was added to a mixed solution, and a concentration of Ga(OH)₃ in the mixed solution was 2000.0 mg/L.

Example 3: The difference from Example 1 lies in that in the step (3), 42 mg of group IIIA metal hydroxide In(OH)₃ was added to a mixed solution, and a concentration of In(OH)₃ in the mixed solution was 280.0 mg/L.

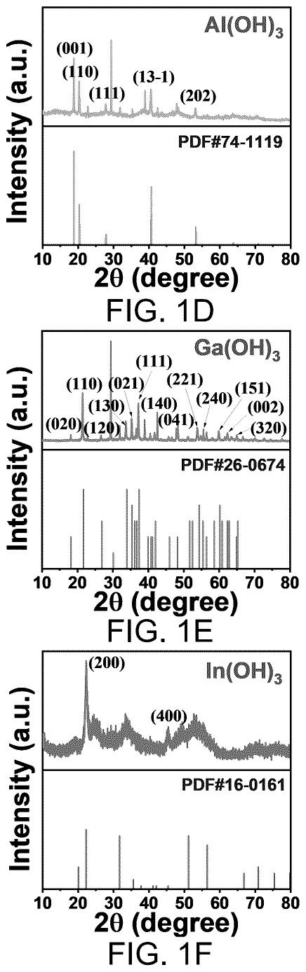

Example 4: The difference from Example 1 lies in that in the step (3), the 300 W mercury lamp as a light source was replaced with a yellow or red LED lamp, the XPA-7 photochemical reactor was replaced with a self-made photoreaction apparatus, and as shown in FIG. 2 (in the figure, 1 represents a quartz tube, 2 represents a radiometer, 3 represents a stirrer, 4 represents an LED lamp, 5 represents a multi-layer test tube rack configured to accommodate a plurality of quartz tubes, and 6 represents a fan for temperature control, where the multi-layer test tube rack is placed on the stirrer, the LED lamp and the fan are arranged around the multi-layer test tube rack, and the radiometer is configured to detect and record light intensities around the quartz tube; the usage method includes: a test solution was added to the quartz tube, then the quartz tube was placed on the multi-layer test tube rack, the stirrer was turned on for fully mixing, then the LED lamp and the fan were turned on, and the light intensity during the reaction was monitored through the radiometer), and the photocatalytic degradation experiment was repeated.

Example 5: The difference from Example 4 lies in that in the step (3), 300 mg of group IIIA metal hydroxide Ga(OH)₃ was added to a mixed solution, and a concentration of Ga(OH)₃ in the mixed solution was 2000.0 mg/L.

Example 6: The difference from Example 4 lies in that in the step (3), 42 mg of group IIIA metal hydroxide In(OH)₃ was added to a mixed solution, and a concentration of In(OH)₃ in the mixed solution was 280.0 mg/L.

Example 7: The difference from Example 4 lies in that in the step (3), the yellow light was replaced with a red LED lamp.

Example 8: The difference from Example 7 lies in that in the step (3), 300 mg of group IIIA metal hydroxide Ga(OH)₃ was added to a mixed solution, and a concentration of Ga(OH)₃ in the mixed solution was 2000.0 mg/L.

Example 9: The difference from Example 7 lies in that in the step (3), 42 mg of group IIIA metal hydroxide In(OH)₃ was added to a mixed solution, and a concentration of In(OH)₃ in the mixed solution was 280.0 mg/L.

Comparative Example 1: Photodegradation of PFOA alone
(1) 100 mg of a PFOA solid was weighed and placed in a 1L volumetric flask, and stirred and dissolved to obtain a 100 mg/L PFOA stock solution;
(2) a 300 W mercury lamp was placed in an XPA-7 photochemical reactor and preheated for 30 min to achieve stable light intensity output; and
(3) 7.5 mL of the 100 mg/L PFOA stock solution was uniformly mixed with 142.5 mL of deionized water to obtain a mixed solution, a pH value of the mixed solution was adjusted to 7 (a concentration of PFOA in the mixed solution was 5 mg/L), then a light irradiation reaction was performed, a lampshade of the photochemical reactor was pulled down at a preset reaction time point, 1.0 mL of a reaction solution was extracted from a photoreaction tube into a 10 mL plastic centrifuge tube, 4 mL of methanol was added, and a resulting mixture was stirred and extracted for 40 min, where a high performance liquid chromatography-mass spectrometry (HPLC-MS) was used to monitor PFOA concentration changes and calculate degradation rates.

Comparative Example 2: The difference from Comparative Example 1 lies in that in the step (2), the 300 W mercury lamp as a light source was replaced with yellow light, the XPA-7 photochemical reactor was replaced with a self-made photoreaction apparatus, and the photodegradation experiment was repeated.

Comparative Example 3: The difference from Comparative Example 2 lies in that in the step (2), the yellow light was replaced with red light, and the photodegradation experiment was repeated.

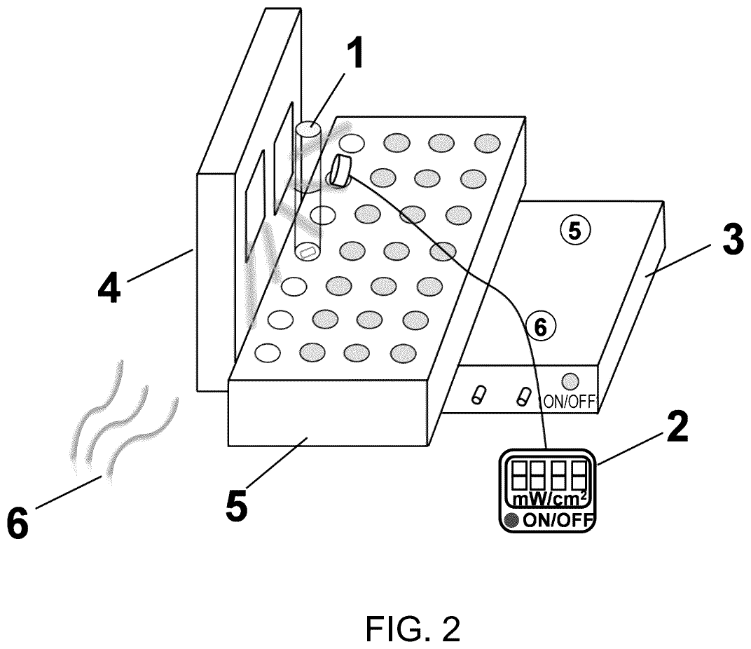

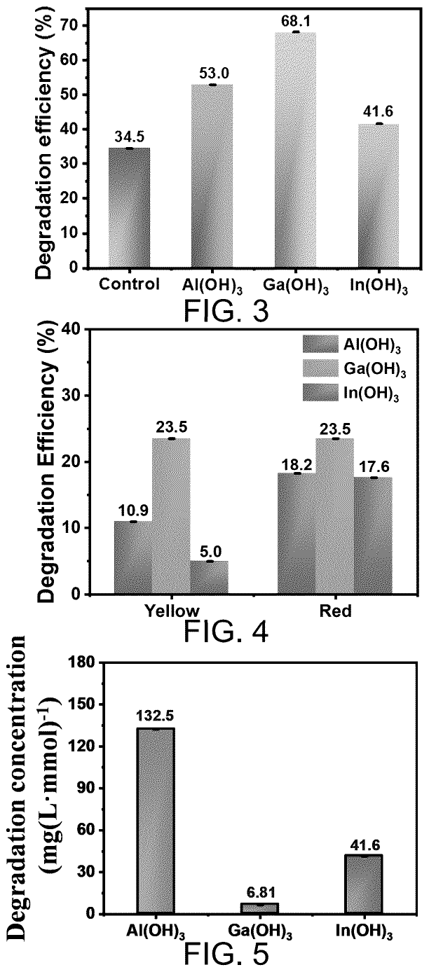

The degradation efficiency of PFOA in Examples 1 to 9 and Comparative Examples 1 to 3 are shown in FIG. 3 and FIG. 4.

As shown in FIG. 3, under optimal reaction conditions, compared with the single photodegradation system, the degradation of PFOA was promoted by 18.5%, 33.6%, and 7.1% respectively after 48 h of UV irradiation with the addition of Al(OH)₃, Ga(OH)₃, and In(OH)₃. PFOA showed no significant degradation under yellow or red LED irradiation, and the photocatalytic efficiency of Al(OH)₃, Ga(OH)₃, and In(OH)₃ on PFOA at an optimal dosage reached up to 23.5% (FIG. 4).

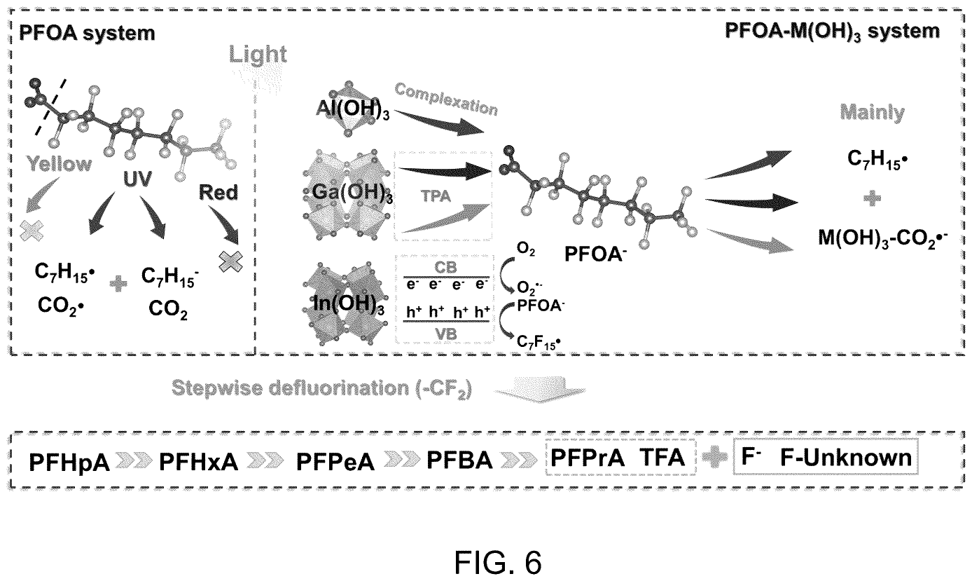

To determine the catalytic performance of Al(OH)₃, Ga(OH)₃, and In(OH)3, a degradation concentration of PFOA per 1 mmol of hydroxide was used for evaluation (formula as follows: degradation concentration (L·mmol⁻¹)=PFOA degradation concentration/amount of substance of hydroxide). An order of utilization efficiency is Al(OH)₃>In(OH)₃>Ga(OH)₃ (as shown in FIG. 5).

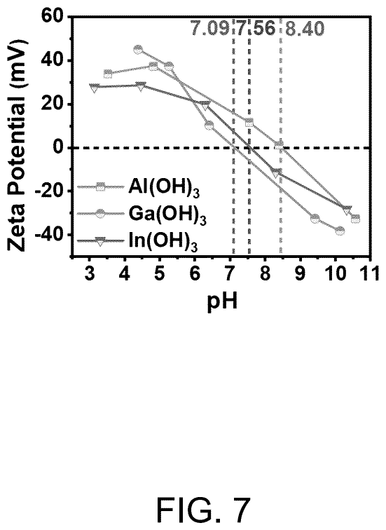

A catalytic mechanism of group IIIA metal hydroxides in the above photocatalytic reaction system is as follows: On one hand, a surface of the synthesized group IIIA metal hydroxide is positively charged under the condition of pH=7, leading to an electrostatic interaction with negatively charged PFOA, PFOA is adsorbed on a hydroxide surface via monodentate coordination, and there exists a weak hydrogen bonding between a CF₂ group of PFOA and a hydroxyl group on the hydroxide surface, where the coordination mode reduces bond energy of α-C—C bond cleavage in PFOA, and under UV irradiation, the α-C—C bond in PFOA is easily dissociated to form C₇H₁₅· and CO₂· upon photoexcitation; on the other hand, holes in the hydroxide are capable of oxidizing PFOA ions; and additionally, under yellow and red light irradiation, the hydroxide has a two-photon absorption effect, which reduces the dissociation energy of the α-C—C bond, thereby facilitating the cleavage of the C—C bond to form C—H₁₅. and CO₂. (FIG. 6).

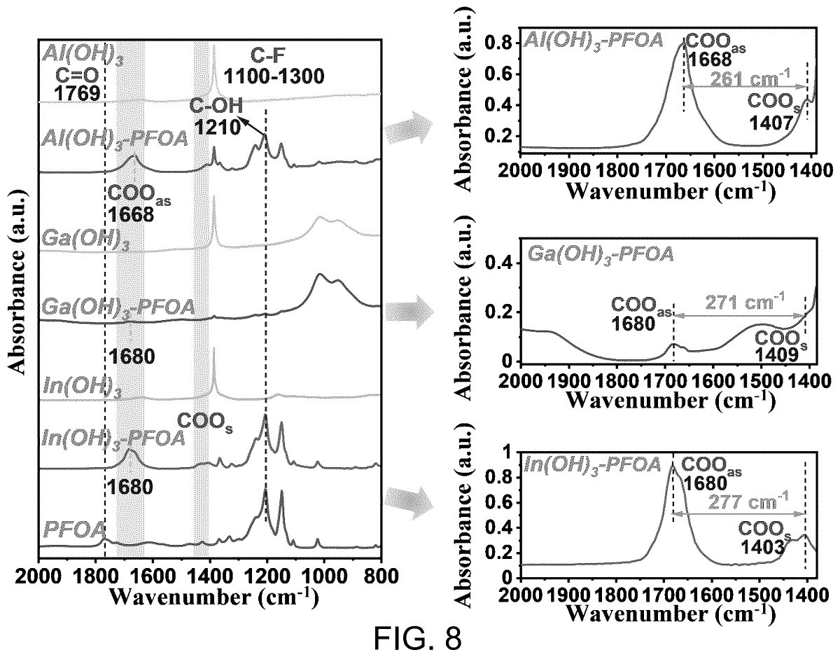

To verify a mechanism of PFOA degradation by hydroxide photocatalysis in the above examples, the Applicant conducted the following experiment: Zero-point charges of the three hydroxides were measured, and the results showed that the zero-point charges of the three hydroxides were 8.40, 7.09, and 7.56 respectively. Under the condition of pH=7, surfaces of the hydroxides were positively charged (FIG. 7).

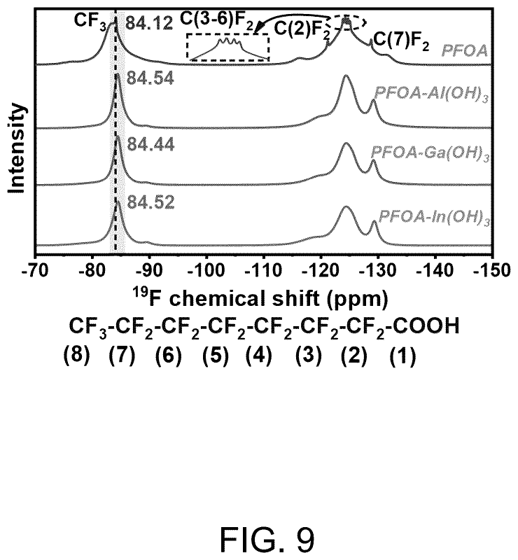

Infrared characterization was performed on original and PFOA-adsorbed hydroxides, and it was obtained according to a calculation formula Δv=vₐₛ(COO⁻)−vₛ(COO⁻): wavenumber differences in the PFOA-Al(OH)₃, PFOA-Ga(OH)₃, and PFOA-In(OH)₃ systems were 261 cm⁻¹, 271 cm ⁻¹, and 277 cm⁻¹ respectively (FIG. 8), and it was confirmed that an interaction between the hydroxide and PFOA was monodentate coordination.

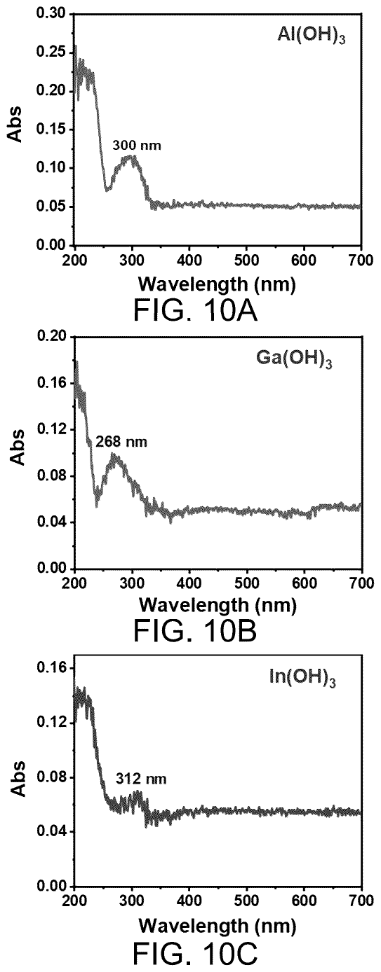

The results of ¹⁹F nuclear magnetic resonance spectroscopy showed that peaks at −84.12, −121.26, −123.88, −124.34, −124.80, 125.14, and −128.82 ppm in a PFOA sample were attributed to terminals C(8)F₃ and C(2-7)F₂ respectively. After PFOA was adsorbed on the hydroxide surface, terminal C(8)F₃ groups in PFOA-Al(OH)₃, PFOA-Ga(OH)₃, and PFOA-In(OH)₃ showed shifts of 0.42, 0.40, and 0.32 ppm respectively. Additionally, peaks of C(3-6)F₂ groups overlapped into one broad peak, indicating that the CF₂ group of PFOA may interact with the hydroxyl group on the hydroxide surface via hydrogen bonding (FIG. 9).

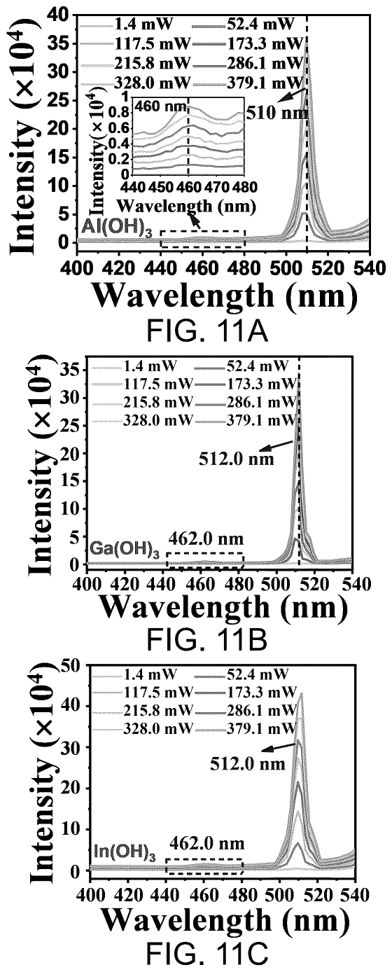

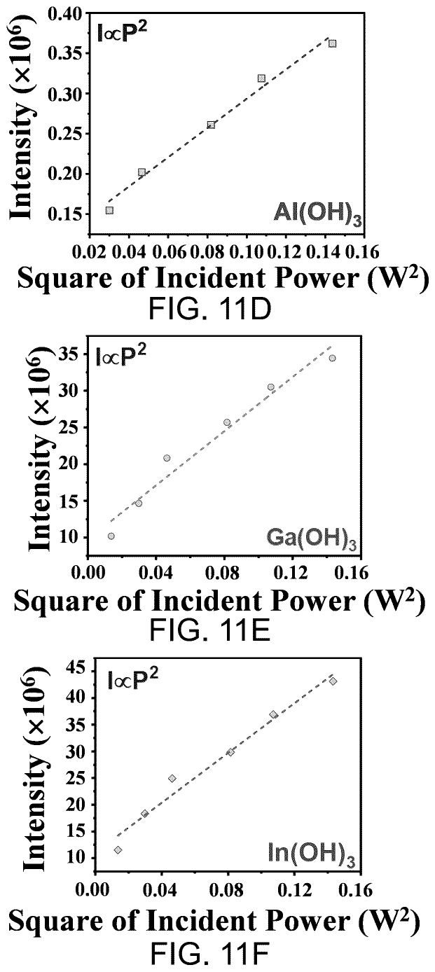

The results of EPR tests, quenching experiments, and aeration experiments showed that the holes in hydroxides could oxidize PFOA ions. The results of ultraviolet-visible diffuse reflectance test showed that Al(OH)₃ had an obvious absorption peak at 300.0 nm. Similarly, Ga(OH)₃ and In(OH)₃ had obvious absorption peaks at 268.0 nm and 312.0 nm respectively, and therefore, band gap energies E_{g} of Al(OH)₃, Ga(OH)₃, and In(OH)₃ were 4.1 eV, 4.6 eV, and 4.0 eV respectively (FIG. 10A~10C). An hv range of yellow to red light (496.0 nm-775.0 nm) was about 1.6 eV-2.5 eV, so a range of hv to 2 hv was 3.2 eV to 5.0 eV. The E_{g} of hydroxide fell within this range, indicating the possible existence of two-photon absorption effect. The hydroxides exhibited an upconversion luminescence effect under 650 nm laser excitation (emission peaks appeared at 510.0 nm and 460.0 nm). The results of variable-power tests show that as excitation power increases, a luminescence intensity is proportional to the square of the power, thereby confirming the existence of the two-photon absorption effect of hydroxides (FIG. 11A~11F).

Example 10: Analysis of influencing factors on PFOA degradation in a photocatalytic system

It can be concluded from the above examples that Al(OH)₃ has the most excellent photocatalytic performance for PFOA degradation. In this example, a pH value of a water body was adjusted to 3-7 or a certain amount of common anions (Cl⁻, SO₄²⁻, HCO₃⁻, and NO₃⁻) were added to the water body for photocatalytic experiments to determine the influence of water quality factors on the performance of Al(OH)₃ for photocatalytic degradation of PFOA.

After 48 h of UV irradiation, Al(OH)₃ showed good photocatalytic effect on PFOA under non-extreme conditions (pH=3.0-7.0); Cl⁻, SO₄²⁻, and HCO₃⁻ had significant inhibitory effects on the PFOA degradation. During a light irradiation reaction for 48 h, degradation rates of PFOA decreased by 4.2%, 15.1%, and 17.5% respectively, while NO₃⁻ had no significant inhibitory effect on the PFOA degradation, with the degradation rate decreasing from 53.0% to 52.8% only.

The above results indicate that group IIIA metal hydroxides, especially the Al(OH)₃ solid, have certain application potential and may be applied for the degradation of PFOA in water bodies.

Comparative Example 4: The difference from Example 2 lies in that the group IIIA metal hydroxide Ga(OH)₃ was replaced with Ga₂O₃, and a concentration used for comparison was 0.5 g/L.

Comparative Example 5: The difference from Example 3 lies in that the group IIIA metal hydroxide In(OH)₃ was replaced with In₂O₃, and a concentration used for comparison was 0.5 g/L.

Results of comparing the degradation efficiency of PFOA in Examples 2 and 3 and Comparative Examples 4 and 5 show that catalytic performance of Ga(OH)₃ for PFOA was about 18% higher than that of Ga₂O₃ under the condition of a same concentration, and the catalytic performance of In(OH)₃ for PFOA was about 12% higher than that of In₂O₃, indicating that group IIIA metal hydroxides have better degradation effect on PFOA than oxides and have broader application prospects.

1. A method for photocatalytic degradation of perfluorooctanoic acid (PFOA) in water using group IIIA metal hydroxides, comprising the following steps:
adding group IIIA metal hydroxide as a photocatalyst to a water body containing PFOA, and performing a photocatalytic degradation reaction under a light source after sufficient mixing, wherein the group IIIA metal hydroxide is aluminum hydroxide, gallium hydroxide, or indium hydroxide.

2. The method according to claim 1, wherein a mass ratio of the PFOA to the aluminum hydroxide is 1:8-12.

3. The method according to claim 1, wherein a mass ratio of the PFOA to the gallium hydroxide is 1:300-600.

4. The method according to claim 1, wherein a mass ratio of the PFOA to the indium hydroxide is 1:40-60.

5. The method according to claim 1, wherein an alkali precipitation method is employed for preparing the group IIIA metal hydroxides, comprising the following steps: dropwise adding a sodium hydroxide solution of a first concentration to a solution containing aluminum salt, gallium salt or indium salt to generate a white flocculent precipitate, then dropwise adding a sodium hydroxide solution of a second concentration to completely generate a precipitate, washing the precipitate with a solvent, drying to obtain a solid, and cooling and grinding the solid, wherein obtained solid powder is the group IIIA metal hydroxide.

6. The method according to claim 5, wherein a concentration of the sodium hydroxide solution of a first concentration is 8-10 M, and a concentration of the sodium hydroxide solution of a second concentration is 1-2 M.

7. The method according to claim 6, wherein a pH range of the water body containing the PFOA is 3-7.

8. The method according to claim 1, wherein the light source is ultraviolet light, yellow light, or red light.

9. The method according to claim 1, wherein conditions of the photocatalytic degradation reaction comprise: reacting at 24-26° C. for 24-50 h.
